(19) United States
(12) Patent Application Publication
(10) Pub. No.: US 2009/0304195 A1
(43) Pub. Date: Dec. 10, 2009

(54) METHOD AND DEVICE FOR DIAGNOSING THE OPERATING STATE OF A SOUND SYSTEM

(75) Inventor: Corinne Fillol, Mouroux (FR)

Correspondence Address: YOUNG & THOMPSON, 209 Madison Street, Suite 500, ALEXANDRIA, VA, 22314, US

(73) Assignee: REGIE AUTONOME DES TRANSPORS PARISIENS, Paris Cedex 12 (FR)

(21) Appl. No.: 12/373,371

(22) PCT Filed: Jun. 26, 2007
(86) PCT No.: PCT/FR2007/001067

§ 371 Date: Feb. 11, 2009

(30) Foreign Application Priority Data
Jul. 13, 2006 (FR) 0606431

(51) Int. Cl. H04R 29/00

(52) U.S. Cl. 381/59

(57) ABSTRACT

The invention relates to a method of diagnosing the operating state, in situ, of a sound system comprising at least one loudspeaker suitable for being connected to an audio player and arranged in an at least partially closed space, characterized in that it comprises the following steps:
broadcasting (32) of acoustic waves representative of a test signal (St(t)) by each loudspeaker into said space;
acquisition (34) of a digital response signal (Sr(t)) representative of the acoustic waves broadcast;
determination (52, 53, 54) of energy distribution coefficients representative of the energy distribution of said digital response signal (Sr(t)) per frequency band; and
comparison (58, 60) of said energy distribution coefficients with predetermined threshold ranges so as to diagnose the operating state of each loudspeaker.

The invention also relates to a diagnostic device suitable for carrying out the above method.

The present invention relates to an in situ method and device for diagnosing the operating state of a public address system.

In spaces receiving the public and in particular in public transport service premises, it is necessary to ensure that the usual information (traffic disruptions, train announcements, etc.) and other messages (evacuation of the premises, warnings, etc.) are understood by all the users.

To this end, a known technique is to check that the public address system is operating correctly by broadcasting “public address test” type messages. An operating agent listens to the response given by the set of loudspeakers of the public address system and determines whether the public address system is operating or not.

However, this type of check does not provide for quantitatively judging the performance levels of the public address system (distortion, sound overlap, intelligibility, etc.).

Another known technique is to measure the gain, the sound pressure in the axis of a loudspeaker and the impedances at the outputs of the amplifiers.

However, these measurements only provide for knowing whether an amplifier or loudspeaker is in an operational state or not, without specific information on the type of fault.

Also known are real-time high-precision tools which provide for measuring the impulse response of a loudspeaker/room system and provide for analyzing the time and frequency responses of the loudspeakers. These tools supply the acoustic characteristics, such as reverberation time, definition, acoustic clarity, spectral signature of the loudspeaker, directivity, etc.

However, these tools are designed for acoustic technicians and sound engineers. They are neither intended for nor can be used by a person who is not specialized in the field of acoustics. Furthermore, they do not provide for performing an in situ diagnosis of the fault on a loudspeaker included in a public address system, by an acoustic measurement.

An aim of the invention is to propose an in situ method for diagnosing the operating state of a public address system, providing a clear diagnosis on the causes of the malfunctioning of the loudspeakers, which can be used by persons who are not specialized in the field of acoustics.

To this end, a subject of the invention is a method for diagnosing the operating state of a public address system comprising at least one loudspeaker intended to be connected to an audio player and arranged in an at least partly closed space, characterized in that it includes the following steps:
excitation of the or each loudspeaker using a predetermined test signal;
broadcast of acoustic waves representative of said test signal by the or each loudspeaker in said space;
acquisition of a digital response signal representative of the acoustic waves broadcast by the or each loudspeaker in said space, by at least one acoustic wave acquisition means;
processing of the digital response signal;
determination of energy distribution coefficients representative of the energy distribution of said digital response signal, per frequency band; and
comparison of said energy distribution coefficients with predefined threshold ranges in order to diagnose the operating state of each loudspeaker.

According to particular embodiments, the method includes one or more of the following features:
the test signal comprises a defined number of sequences of a pseudorandom signal, and said processing step includes the following steps:
   time partitioning of the digital response signal into a number of sequences equal to the defined number of sequences of the test signal;
   determination of an averaged sequence of the response signal by calculating the point-to-point average of said sequences of the partitioned digital response signal; and
   determination of a sequence of the impulse response signal from said averaged sequence of the response signal;
the public address system includes several loudspeakers, and the step for processing the digital response signal additionally includes a step for determining blocks of the impulse response signal, each block of the impulse response signal being representative of the acoustic waves broadcast by a single loudspeaker in said space;
the step for determining the energy distribution coefficients comprises a step for filtering the or each block of the impulse response signal;
the step for determining the energy distribution coefficients comprises a step for calculating energy distribution coefficients per one-third octave in a Wigner-Ville distribution, from the or each block of the impulse response signal;
the step for determining the energy distribution coefficients comprises a step for calculating energy distribution coefficients per unit of frequency and per unit of time in a Friedman distribution, from the or each block of the impulse response signal;
the diagnosis method includes, prior to the step for determining the energy distribution coefficients, the following steps:
   measurement of the distance between the or each loudspeaker and the or each acoustic wave acquisition means;
   calculation of the performance of the public address system;
   display of a message indicating the performance and stopping of the diagnosis method when the performance is less than a predefined threshold value; and
   the performance is calculated from the following formula:

$$R = \frac{Nr \times {D}^{2}}{Ne} ,$$

where:
R represents the performance;
Nr represents the sound level received by the acoustic wave acquisition means;
Ne represents the sound level emitted by the loudspeaker or loudspeakers; and
D represents the distance or the average distance between the acoustic wave acquisition means and the loudspeaker or loudspeakers;
the comparison step is preceded by a step for selecting discriminant coefficients from among said energy distribution coefficients, and the comparison step is performed using at least one binary decision tree containing said discriminant coefficients; and
the operating state of the public address system determined by said method comprises a healthy loudspeaker operating state, a membrane-pierced loudspeaker operating state and a degraded loudspeaker operating state.

Another subject of the invention is a device for diagnosing the operating state of a public address system arranged in an at least partly closed space and comprising at least one loudspeaker, characterized in that it includes:
a metrological quality audio player intended to be connected to each loudspeaker and able to play a test signal;
at least one means for acquiring acoustic waves broadcast by each loudspeaker in said space, each acquisition means being adapted to transform said acoustic waves into a digital response signal;
means for measuring the distance or distances between each loudspeaker and each acquisition means;
calculation means intended to receive the digital response signal and a signal containing the measured distance information, said calculation means being able to execute the abovementioned steps of the method, starting from the digital response signal and from a signal containing the measured distance information.

The invention will be better understood on reading the following description given purely by way of example and with reference to the appended drawings in which:

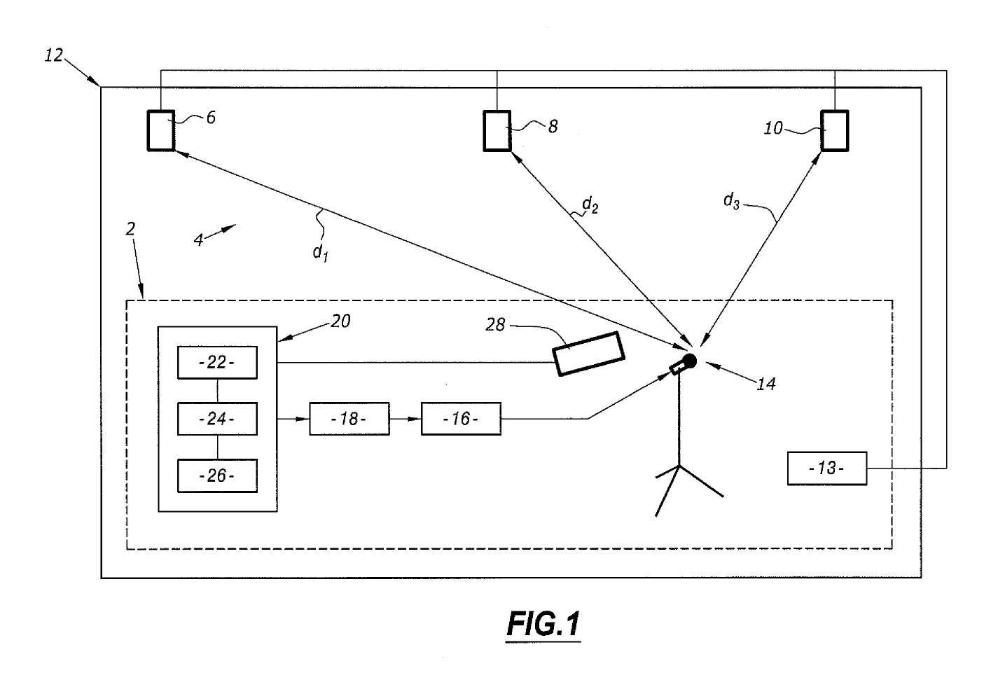

FIG. 1 is a simplified block diagram of the diagnosis device according to the invention;

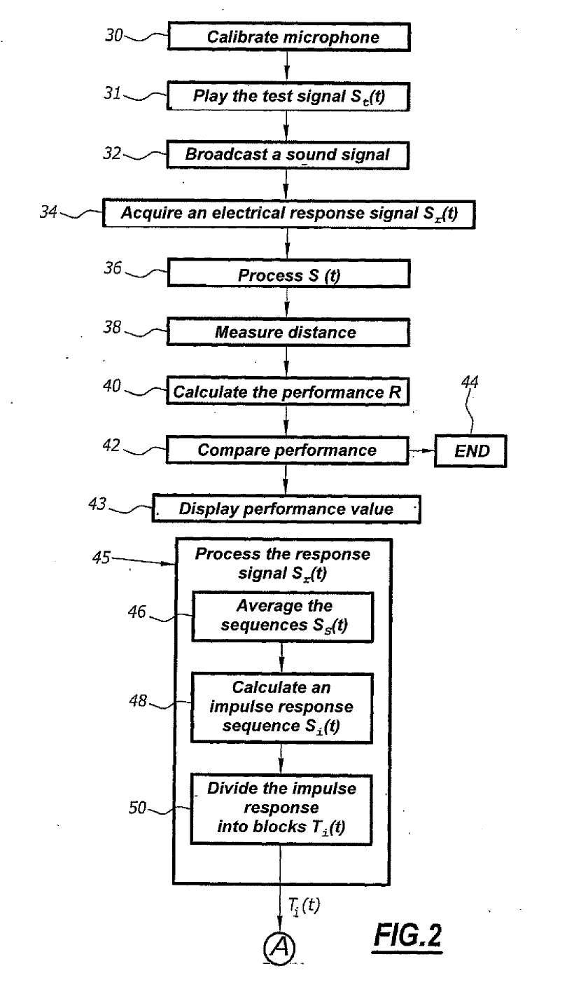

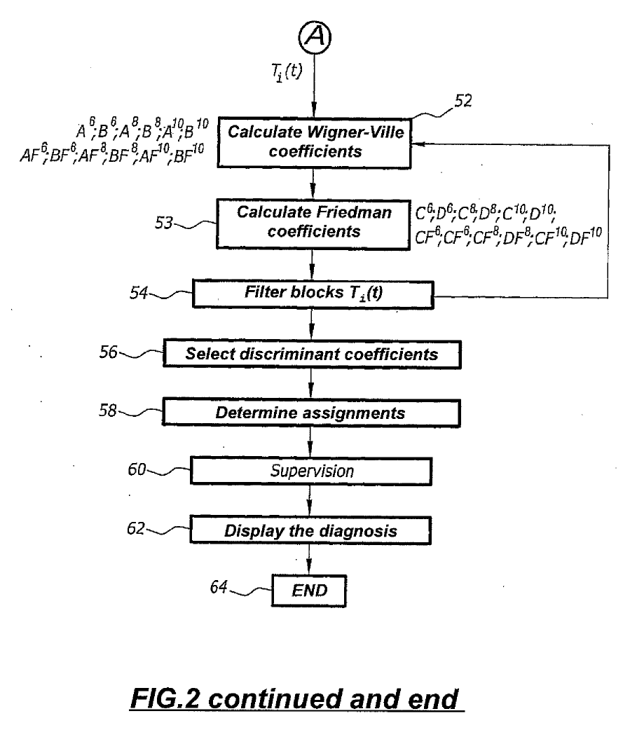

FIG. 2 is a diagram illustrating the main steps of the diagnosis method according to the invention;

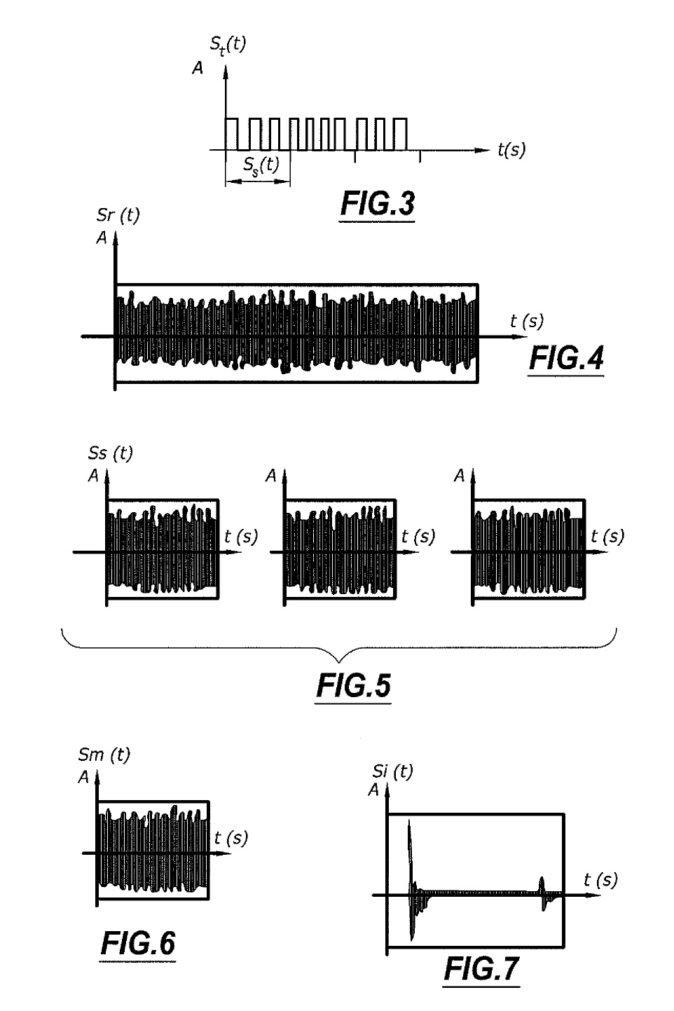

FIG. 3 is a graph representing a test signal St(t) containing three sequences of a periodic pseudorandom signal;

FIG. 4 is a graph representing the digital response signal Sr(t);

FIG. 5 is a graph representing the digital response signal Sr(t) divided into three sequences;

FIG. 6 represents a sequence Ss(t) of the digital response signal, which sequence is obtained by calculating the average of the three sequences represented in FIG. 5;

FIG. 7 is a graph representing a sequence Si(t) of the impulse response digital signal;

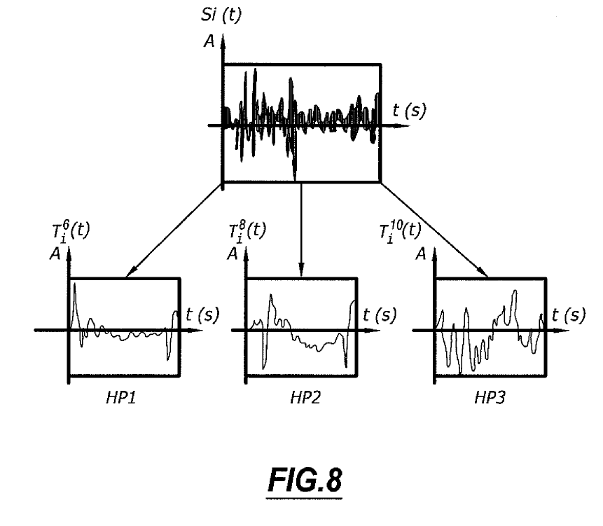

FIG. 8 is a diagram representing three blocks Ti6(t), Ti8(t), Ti10 (t) of the sequence Si(t) of the impulse response digital signal; and

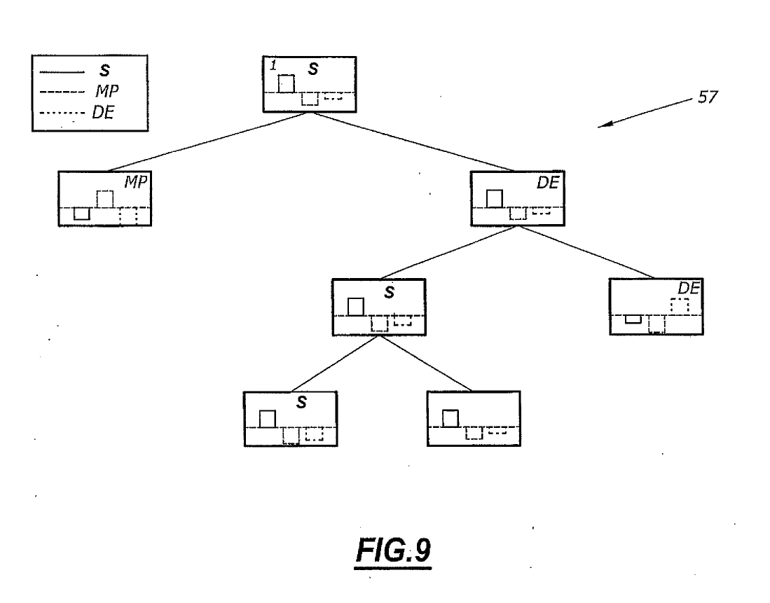

FIG. 9 is a simplified diagram representing a binary decision tree.

The diagnosis device 2 for a public address system 4 according to the invention is illustrated in FIG. 1.

The public address system 4 conventionally includes a set of several loudspeakers 6, 8, 10 fitted in a space 12.

The diagnosis device 2 is intended to differentiate between various types of faults of the public address system 4 and in particular to classify each loudspeaker as being either in an operating state referred to as healthy “S”, or in operating states referred to as out-of-phase “DEPH” or “OFF”, or in a state referred to as membrane-pierced “MP” in which all or some of the membrane suspension is separated from the rest of the coil, or in a state referred to as degraded “DE” revealing environmental degradations such as an excess of particle dust in the loudspeaker enclosure.

The space 12 is a semi-closed public space, generally large in size, such as for example a metro station or a station concourse.

The diagnosis device 2 according to the invention comprises an audio player 13, a microcomputer 20, a sound card 18, and a conditioner 16 connected to one or more units for transforming acoustic waves into a digital response signal Sr(t) which are connected to the conditioner 16 in order to amplify the resulting digital response signal.

The audio player 13 is a high precision metrological quality player, for example of the DAT (Digital Audio Tape) type. This player 13 is able to play a test signal St(t) recorded on a metrological quality recording medium without a shift or time distortion of this test signal St(t).

In the example implementation of the invention represented in FIG. 1, the unit for converting acoustic waves into a digital signal is a microphone 14.

The sound card 18 has an input connected to the conditioner 16 and an output connected to the microcomputer 20.

To ensure the quality of the diagnosis device 2, it is necessary to use the same sound card 18 to digitize the digital response signal Sr(t) received by the microphone 14 as the sound card 18 used during the recording of the test signal St(t) in order to be protected against the clock-frequency disparities of the different systems.

Conventionally, the microcomputer 20 comprises a storage memory 22, a central processing unit 24 and a display screen 26.

The device 2 also comprises a distance measurement unit 28, of high precision, for example of the infrared type. This unit is connected to the microcomputer 20 or is used as a free unit and must able to measure the distances d1, d2, d3 between the loudspeakers 6, 8 and 10 and the microphone 14.

The method for diagnosing the operating state of the public address system 4 is illustrated in FIG. 2.

The method starts with a preliminary step 30 for calibrating the microphone 14 using a calibrator.

At a step 31, the audio player 13 transmits to the loudspeakers 6, 8, 10 a test signal St(t) recorded beforehand on the metrological quality recording medium.

The test signal St(t) is a periodic pseudorandom signal made up of n sequences Ss(t) referred to as Maximum Length Sequences (MLSs). Each sequence is made up of a series of binary pulses. The number n is any integer number. In the example represented in FIG. 3, the number n is equal to three.

At a step 32, the loudspeakers 6, 8, 10 broadcast in the space 12 acoustic waves representative of the test signal St(t) transmitted by the player 13.

At a step 34, the microphone 14 acquires acoustic waves representative of the waves broadcast by the loudspeakers in the space 12.

The microphone 14 transforms the received waves into a digital response signal Sr(t), as represented in FIG. 4.

At a step 36 for processing the digital response signal Sr(t), the latter is amplified by the conditioner 16, digitized by an analogue-to-digital converter contained in the sound card 18 and transmitted to the central processing unit 24.

At a step 38, the unit 28 measures the distances d1, d2, d3 between each loudspeaker 6, 8, 10 and the microphone 14 and transmits a signal containing information on these distances d1, d2, d3 to the central processing unit 24.

At a step 40, the central processing unit 24 calculates the performance R of the public address system 4 from the following formula:

$$R = \frac{Nr \times {D}^{2}}{Ne}$$

where:
D represents the average distance between the microphone 14 and the loudspeakers 6, 8, 10, calculated from the measured distances d1, d2 and d3;

$$D = \frac{{\sum }_{1}^{N} {d}_{i}}{N}$$

where N=number of loudspeakers retained and di=measured distances; and
Ne represents the sound level emitted by the set of loudspeakers 6, 8, 10 and Nr represents the sound level received by the microphone 14.

Conventionally, the sound level represents the level of a logarithmic measurement scale of sound intensities or power levels.

At a step 42, the central processing unit 24 compares the value of the performance R calculated at the step 40 with a predefined threshold value prerecorded in the memory 22 and modifiable by the user according to the performance level demanded for the diagnosis method.

If this performance value R is less than the predefined threshold value, the performance value R is displayed on the screen 26 at a step 43 and the diagnosis method stops at a step 44.

If, on the other hand, the performance value R is greater than the predefined value, the digital response signal Sr(t) is analyzed more finely to work out whether one or more of the loudspeakers are faulty, at a step 45.

In that case, the response signal Sr(t) processed at the step 36 is first averaged at a step 46.

To this end, the response signal Sr(t) acquired as a response to the broadcast of the three sequences of the test signal St(t) is divided or partitioned in time into three sequences Ss(t).

Consequently, each sequence Ss(t) of the response signal has a time length equal to the time length of a sequence of the test signal St(t).

Then, the central processing unit 24 determines the average value of these three sequences Ss(t) of the response signal by point-to-point addition of each digitized amplitude of a sequence Ss(t) of the response signal and by dividing these amplitudes by the number of added sequences, i.e. three in the example described above.

At a step 48, the central processing unit 24 calculates the sequence Si(t) of the impulse response signal from the sequence Sm(t) of the averaged response signal using, for example, a Hadamard transform.

The Hadamard transform is known per se. It is obtained by multiplying the sequence Sm(t) of the averaged response signal by a square matrix of order N×N, the elements of which have the values +1 or −1 and the rows of which, respectively the columns of which, are mutually orthogonal.

The software of registered trademark MATLAB proposes a function for calculating the Hadamard transform of a digital signal. It can be used to implement the steps of the method according to the invention. An example of a sequence Si(t) of the impulse response signal obtained by this transform is represented in FIG. 7.

At a step 50, the sequence Si(t) of the impulse response signal is separated or divided into blocks Ti6(t), Ti8(t), Ti10(t), such that each block Ti6(t), Ti8(t), Ti10(t) is representative of the acoustic waves broadcast by a single loudspeaker 6, 8, 12.

This separation is achieved, for example, by a “spatio-temporal bistoury” based on the distances d1, d2, d3 measured by the unit 28. The spatio-temporal bistoury is a method which comprises the steps described below:

To separate the blocks of the sequence of the impulse response signal from each loudspeaker, the spatio-temporal bistoury method comprises a step for searching for the time t0 corresponding to the first pulse of the sequence of the impulse response signal Si(t), then a step for performing a first separation into three blocks Ti6(t), Ti8(t), Ti10(t) based on time t0 and distances d1, d2, d3.

Then, the spatio-temporal bistoury method comprises a step for searching for the peaks of the sequence Si(t) of the impulse response signal, for example by calculating second derivatives.

Lastly, it uses the peaks thus calculated to confirm the separation of the impulse response signal into blocks Ti6(t), Ti8(t), Ti10(t), carried out beforehand.

FIG. 8 represents three blocks Ti6(t), Ti8(t), Ti10(t) of the impulse response signal Si(t) corresponding to the three loudspeakers 6, 8 and 10.

At a step 52, energy distribution coefficients of the acoustic waves generated by each loudspeaker 6, 8, 10 are calculated from the blocks Ti6(t), Ti8(t), Ti10(t) of the impulse response signal of each loudspeaker.

To this end, a Wigner-Ville distribution graph is produced from the formula described below and known per se:

$${W}_{x} ( t , v ) = {\int }_{- ∞}^{+ ∞} x ( t + τ / 2 ) x ⋆ ( t - τ / 2 ) {e}^{- j 2 π v τ} d τ$$

where v is the frequency, τ is the sampling period of the signal and x* is the complex conjugate of the signal x.

The Wigner-Ville distribution provides for representing in a three-dimensional space the energy distribution of a block Ti6(t), Ti8(t), Ti10(t) of the impulse response signal as a function of time and frequency.

The MATLAB software can, for example, be used to produce the representation of this distribution.

From this distribution, the central processing unit 24 calculates an energy distribution coefficient by summing, over a frequency band having a width corresponding to one-third octave, the energy of a block Ti6(t) of the impulse response signal.

This summation of the energy of a block Ti6(t) of the impulse response signal is carried out for each frequency band 52A, 52B, 52C of one-third octave width in the Wigner-Ville distribution space. Thus, this calculation provides for obtaining a series A6 of energy distribution coefficients per frequency band, of one-third octave width, as designated below:

A6=(a 1/36, a 2/36, a 3/36, a 4/36, etc.)

The central processing unit 24 also calculates the sum of the energy per unit of time and per unit of frequency in the Wigner-Ville distribution space.

To this end, the Wigner-Ville space is divided on the one hand into equal-width frequency bands and, on the other hand into equal-width time bands.

This calculation provides for obtaining a series B6 of energy distribution coefficients b16, b26, b36, b46, etc. per unit of frequency and per unit of time, as designated here: B6=(b16, b26, b36, b46, etc.).

Then, at a step 53, the central processing unit 24 calculates a Friedman probability distribution from a formula that is known per se and described in the document: D. H. Friedman, “Instantaneous Frequency vs Time: An Interpretation of the Phase Structure of Speech”, Proc. IEEE ICASSP, pp. 29.10 1-4, Tampa, 1985.

From this Friedman distribution, the central processing unit 24 calculates the energy distribution coefficients per frequency band of one-third octave width: C6=(c 1/36, c 2/36, c 3/36, c 4/36, etc.), and the energy distribution coefficients per unit of frequency and per unit of time: d6=(d16, d26, d36, d46, etc.).

The series A8, B8, C8, D8 and A10, B10, C10, D10 of energy distribution coefficients for the blocks Ti8(t) and Ti10(t) of the impulse response signal corresponding to the loudspeakers 8 and 10 are also calculated from their Wigner-Ville distribution graph.

A8=(a 1/38, a 2/38, a 3/38, a 4/38, etc.); A10=(a 1/310, a 2/310, a 3/310, a 4/310, etc.)

B8=(b18, b28, b38, b48, etc.); B10=(b110, b210, b310, b410, etc.)

C8=(c 1/38, c 2/38, c 3/38, c 4/38, etc.); C10=(c 1/310, c 2/310, c 3/310, c 4/310, etc.)

D8=(d18, d28, d38, d48, etc.); D10=(d110, d210, d310, d410, etc.)

At a step 54, the blocks Ti6(t), Ti8(t), Ti10(t) of the response signal are filtered.

The filters are band-pass filters specified explicitly for each operation, i.e. S (healthy), OFF or DEPH (out-of-phase) operation, MP (membrane-pierced) operation and DE (degraded) operation, with the aim of revealing the differences between these operations.

In particular, the filters used have been designed to highlight the energy that is characteristic of the fault and to eliminate the energy related to the type of loudspeaker used.

The filters have been designed empirically, trying to increase as far as possible the visual differences between the defective and healthy signals. Generally, these filters mainly highlight the low and high frequency bands. These filters can be implemented using the utility of registered trademark “MATLAB, SP TOOL”.

At a step 52, other distribution coefficients are calculated from the three blocks Ti6(t), Ti8(t), Ti10(t) of the impulse response signal which are filtered by one or more predefined filters according to the method explained above.

The series of coefficients obtained are referenced AF6, BF6, CF6, DF6.

At a step 56, energy distribution coefficients referred to as discriminant are selected from among the set of distribution coefficients contained in the series Ax, Bx, Cx, Dx, AFx, BFx, CFx, DFx, for x=6, 8, 10; according to predetermined criteria in an empirical manner on a set of defective and healthy loudspeakers.

These discriminant coefficients are compared with predetermined threshold ranges in an empirical manner according to statistical analyses and studies based on signals acquired in an anechoic chamber, in a laboratory and in a “real” place, such as a station, a metro train, etc.

It must be emphasized that all the faults are not identified by the same methods:
the “OFF” fault on the loudspeakers is differentiated by means of a simple comparison of one of the metrics with a fixed threshold,
the loudspeakers not diagnosed as “OFF” are classified according to the decision tree process,
the “out-of-phase” loudspeakers are identified from the sign of the impulse response Ti(t).

To this end, the discriminant coefficients are introduced in three decision trees 57 containing predetermined threshold ranges.

A decision tree is a series of binary decisions which leads to assigning the tested loudspeaker to a state determined from among the predefined operating states, i.e. a healthy state S, a membrane-pierced state MP and a degraded state DE. An example decision tree 57 is represented in FIG. 9.

Consequently, at a step 58, the three decision trees each assign an operating state to each loudspeaker 6, 8, 10.

At a step 60, these three assignments are introduced in a last decision tree which provides by the same binary routing process a definitive diagnosis describing for each loudspeaker 6, 8, 10 of the public address system its operating state.

At a step 62, the central processing unit 24 displays a diagnosis on the screen 26 and the method stops at a step 64.

Advantageously, the method of the invention provides a diagnosis relating to the operation of each loudspeaker in only one measurement. It avoids the need for an operator to intervene on each loudspeaker.

1-10. (canceled)

11. A method for diagnosing the operating state of a public address system (4) comprising at least one loudspeaker (6, 8, 10) intended to be connected to an audio player (13) and arranged in an at least partly closed space (12), characterized in that it includes the following steps:
excitation (31) of the or each loudspeaker (6, 8, 10) using a predetermined test signal (St(t));
broadcast (32) of acoustic waves representative of said test signal (St(t)) by the or each loudspeaker (6, 8, 10) in said space (12);
acquisition (34) of a digital response signal (Sr(t)) representative of the acoustic waves broadcast by the or each loudspeaker (6, 8, 10) in said space (12), by at least one acoustic wave acquisition means (14);
processing (46, 48, 50) of the digital response signal (Sr(t));
determination (52, 53, 54) of energy distribution coefficients (ayx, byx, cyx, afyx, bfyx, cfyx, dyx, dfyx) representative of the energy distribution of said digital response signal (Sr(t)), per frequency band; and
comparison (58, 60) of said energy distribution coefficients (ayx, byx, cyx, afyx, bfyx, cfyx, dyx, dfyx) with predefined threshold ranges in order to diagnose the operating state (S, MP, DE, OFF, DEPH) of each loudspeaker (6, 8, 10).

12. A diagnosis method according to claim 11, characterized in that the test signal (St(t)) comprises a defined number (n) of sequences of a pseudorandom signal, and in that said processing step (46, 48, 50) includes the following steps:
time partitioning (46) of the digital response signal (Sr(t)) into a number of sequences (Ss(t)) equal to the defined number (n) of sequences of the test signal (St(t));
determination (46) of an averaged sequence (Sm(t)) of the response signal by calculating the point-to-point average of said sequences (Ss(t)) of the partitioned digital response signal; and
determination (48) of a sequence (Si(t)) of the impulse response signal from said averaged sequence (Sm(t)) of the response signal.

13. A diagnosis method according to claim 12, characterized in that said public address system (4) includes several loudspeakers (6, 8,10), and in that the step (46, 48, 50) for processing the digital response signal (Sr(t)) additionally includes a step (50) for determining blocks (T6(t), T8(t), T10(t)) of the impulse response signal (Si(t)), each block (T6(t), T8(t), T10(t)) of the impulse response signal being representative of the acoustic waves broadcast by a single loudspeaker (6, 8, 10) in said space (12).

14. A diagnosis method according to claim 13, characterized in that the step (52, 53, 54) for determining the energy distribution coefficients (ayx, byx, cyx, afyx, bfyx, cfyx, dyx, dfyx) comprises a step (54) for filtering the or each block (T6(t), T8(t), T10(t)) of the impulse response signal.

15. A diagnosis method according to claim 13, characterized in that the step (52, 53, 54) for determining the energy distribution coefficients (ayx, byx, cyx, afyx, bfyx, cfyx, dyx, dfyx) comprises a step (52) for calculating energy distribution coefficients per one-third octave in a Wigner-Ville distribution, from the or each block (T6(t), T8(t), T10(t)) of the impulse response signal.

16. A diagnosis method according to claims 13, characterized in that the step (52, 53, 54) for determining the energy distribution coefficients (ayx, byx, cyx, afyx, bfyx, cfyx, dyx, dfyx) comprises a step (53) for calculating energy distribution coefficients per unit of frequency and per unit of time in a Friedman distribution, from the or each block (T6(t), T8(t), T10(t)) of the impulse response signal.

17. A diagnosis method according to claim 11, characterized in that it includes, prior to the step (52, 53, 54) for determining the energy distribution coefficients (ayx, byx, cyx, afyx, bfyx, cfyx, dyx, dfyx), the following steps:
measurement (38) of the distance (d1, d2, d3) between the or each loudspeaker (6, 8, 10) and the or each acoustic wave acquisition means (14);
calculation (40) of the performance of the public address system (4);
display (43) of a message indicating said performance (R) and stopping (44) of the diagnosis method when said performance (R) is less than a predefined threshold value; and
in that said performance (R) is calculated from the following formula:
$$R = \frac{Nr \times {D}^{2}}{Ne} ,$$
where:
R represents the performance;
Nr represents the sound level received by the acoustic wave acquisition means (14);
Ne represents the sound level emitted by the loudspeaker or loudspeakers (6, 8, 10); and
D represents the distance or the average distance between the acoustic wave acquisition means (14) and the loudspeaker or loudspeakers (6, 8, 10).

18. A diagnosis method according to claim 11, characterized in that the comparison step (58, 60) is preceded by a step (56) for selecting discriminant coefficients from among said energy distribution coefficients (ayx, byx, cyx, afyx, bfyx, cfyx, dyx, dfyx), and in that the comparison step (58, 60) is performed using at least one binary decision tree (57) containing said discriminant coefficients.

19. A diagnosis method according to claim 11, characterized in that the operating state of the public address system (4) determined by said method comprises a healthy (S) loudspeaker (6, 8, 10) operating state, a membrane-pierced (MP) loudspeaker (6, 8, 10) operating state and a degraded (DE) loudspeaker (6, 8, 10) operating state.

20. A device (2) for diagnosing the operating state of a public address system (4) arranged in an at least partly closed space (12) and comprising at least one loudspeaker (6, 8, 10), characterized in that it includes:
a metrological quality audio player (13) intended to be connected to each loudspeaker (6, 8, 10) and able to play a test signal (St(t));
at least one means (14) for acquiring acoustic waves broadcast by each loudspeaker (6, 8, 10) in said space (12), each acquisition means (14) being adapted to transform said acoustic waves into a digital response signal (Sr(t));
means (28) for measuring the distance or distances (d1, d2, d3) between each loudspeaker (6, 8, 10) and each acquisition means (14);
calculation means (24) intended to receive the digital response signal (Sr(t)) and a signal containing the measured distance information (d1, d2, d3), said calculation means (24) being able to execute the steps of the method according to claim 11, starting from the digital response signal (Sr(t)) and from a signal containing the measured distance information (d1, d2, d3).
